(19) United States
(12) Patent Application Publication
(10) Pub. No.: US 2025/0355994 A1
(43) Pub. Date: Nov. 20, 2025

(54) APPARATUS FOR SECURE MACHINE LEARNING MODEL TRAINING, A METHOD FOR SECURE MACHINE LEARNING MODEL TRAINING AND A NON-TRANSITORY MACHINE-READABLE STORAGE MEDIUM

(71) Applicant: Intel Corporation, Santa Clara, CA (US)

(72) Inventors: Mateusz BRONK, Gdansk (PL); Arkadiusz BERENT, Tuchom (PL); Piotr ZMIJEWSKI, Gdansk (PL); Krystian MATUSIEWICZ, Gdansk (PL)

(21) Appl. No.: 18/921,080

(22) Filed: Oct. 21, 2024

(51) Int. Cl. G06F 21/53; G06N 20/00

(52) U.S. Cl. CPC G06F 21/53; G06N 20/00; G06F 2221/033

(57) ABSTRACT

It is provided an apparatus comprising interface circuitry, machine-readable instructions, and processing circuitry to execute the machine-readable instructions. The machine-readable instructions include instructions to obtain a machine learning model and data within a trusted execution environment. The data is configured for training of the machine learning model. The trusted execution environment secures a training of machine model against unauthorized access. The machine-readable instructions further include instructions to verify at least one of the machine learning model and the data and to perform training of the machine learning model based on the data, if the verification of the at least one of the data and the machine learning model is successful. The machine-readable instructions further include instructions to verify the training process of the machine learning model and to output the trained machine learning model from the trusted execution environment, if the verification of the training process is successful.

### BACKGROUND

As machine learning models become more sophisticated and integrated into critical decision-making processes, the need to secure the training and deployment of these models has grown. One of the concerns in this context is protecting the confidentiality and integrity of both the data used to train these machine learning models, and the machine learning models themselves, especially when they are deployed in shared or untrusted computing environments such as cloud platforms. Further, there may be a risk of unauthorized access, data exfiltration, and model tampering, which may lead to compromised predictions and significant security and privacy breaches.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a flowchart of an example of a method;

FIG. 3 illustrates an example of a flow chart of the proposed technique;

FIG. 4 illustrates an example of a block diagram of the proposed technique;

FIG. 5 illustrates a first deployment mode of the described technique; and

FIG. 6 illustrates a second deployment mode of the described technique.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

When machine learning model training is performed under the control of the data owner (also referred to as next to the data), for example in order to not expose the raw training set to model owner, even if the machine learning model training is performed inside a secure environment (such as TEE) the data owner may: 1) Observe learning telemetry, to exfiltrate data through side-channels (steal the model); 2) Feed hostile inputs to the model (cripple the model). When machine learning model training is performed under the control of the machine learning model owner (also referred to as next to the machine learning model), the machine learning model owner who performs the training may: 1) Link samples to their origin, that is (partially) deanonymize samples (even if fully encrypted); 2) Exfiltrate input data (trivial if the model is fully opaque to data producers, but possible even in confidential federated learning cases, where the model owner who can observe the learning can emit portions of raw input through carefully created side channels); 3) Abuse the training set purpose (use for training other models). For example, a pharmaceutical company may have a machine learning model for assessing the effectiveness of their new vaccine (both: model and inference results are confidential IP). The machine learning model may be trained on hospital patient data, which needs protection from deanonymization, but the machine learning model may also be sensitive to an insider attack (for example, competing big pharma company) which is feeding it a biased input sample (attacking just one of data sources).

In previous approaches the machine learning model training and inference is performed on a neutral ground, for example by a trusted third party, which is providing a secure (unbiased) arbitration platform, which is protecting the interests of both parties: The machine learning model owner and data owner, and/or against side-channel attacks. For example, in a previous approach federated learning was performed, for example, privacy preserving federated learning, confidential federated learning and/or block-chained federated learning may be used. In other previous approaches confidential machine learning (ConfML) may be used, comprising trust engines (TEE) and 3rd parties. In other previous approaches secure multiparty computation may be used. In other previous approaches differential privacy may be used. In other previous approaches homomorphic encryption may be used.

These previous approaches may cater to some applications, but they all assume a degree of trust on at least 2 parties out of the three: 1) the data provider, 2) machine learning model provider, 3) the party executing the learning. These approaches may tolerate one dishonest party (or honest, but curious): 1) or 2), the weakest link (esp. for federated learning) may be the compute location: 3) (for example the central server), which may leak the data which helped train the model.

Some previous approaches may require privacy vs. accuracy tradeoffs (for example it is common for data owners to provide scrambled data, learning working on scrambled set, following by resulting model unscramble). Other challenges may include transparency, efficiency, market making (for example incentivizing good partners) and privacy, especially if side-channels are in scope (for example if learning process can be observed by a bad actor, merely deploying confidential computing is not helping on its own). Further, these approaches may be prone backdoor attacks as for example described in “Backdoor Attack Based on Privacy Inference against Federated Learning”; Wu, Hao, Wei, Hao, Han, He; 2024; and “Against Backdoor Attacks In Federated Learning With Differential Privacy”, Miao, Yang, Hu, Li, Huang; 2022.

The herein disclose technique may insulate the machine learning mode training process from the input dataset so that neither party (neither data provide nor machine learning model owner) can influence the other during the training process. The trained model may be released only after the process is completed and meets certain criteria (possibly after a delay or additional gates, incl. payments). The herein described technique (also referred to as machine learning model training airlock, see below) may comprise: a software and TTE-based arbitration/guardian component, forcing an airgap between inputs and outputs, whilst deferring the result acquisition (zero-knowledge during learning process, results available after explicit release). Such an airgap (having access to cleartext data and model weights), may also perform statistical tests for the learning telemetry and outputs matching/mismatching pre-determined profile as well as making sure poisoned learning data sets are not passed on to the machine learning model (an antivirus for training data).

Further, the herein disclosed technique may also be applied to the inference phase (for a locked down confidential model, executed on premises but only for certain queries/prompts).

The herein disclosed technique allows to place the training process of the machine learning model anywhere and under the control of any party, while maintaining arbitration and assuming mutual distrust between all parties, and effectively eliminating the need for extra brokerage.

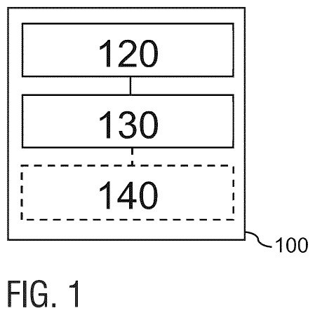

FIG. 1 illustrates a block diagram of an example of an apparatus 100 or device 100 for secure machine learning model training. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to obtain a machine learning model and data within a trusted execution environment (TEE). The data is configured for training of the machine learning model. The trusted execution environment secures a training of machine model against unauthorized access. The TEE (also referred to as TEE architecture to distinguish from an instance of the TEE) may comprise a combination of specialized hardware and software components designed to protect data and computations from unauthorized access and tampering within a computer system. The TEE architecture may provide secure processing circuitry, which is responsible for executing sensitive workloads in an isolated environment. Additionally, the TEE architecture may provide secure memory, such as a protected region of the computer system's RAM, where sensitive data can be stored during computation. To further safeguard this data, the TEE architecture may provide memory encryption, ensuring that the contents of the system memory are protected even if physical access to the memory is obtained. For example, the TEE architecture may support I/O isolation and secure input/output operations, preventing data leakage during communication between the processing circuitry and peripheral devices. In some examples, the TEE architecture may provide secure storage capabilities of the computer system, such as a secure partition within the system's main storage, dedicated to storing cryptographic keys, sensitive configuration data. This secure storage ensures that critical data remains protected even when at rest. In some examples, the TEE architecture may also comprise separate secure storage components, such as a tamper-resistant storage chip, like an integrity measurement register, to securely store measurements of the TEE and/or critical data associated with the TEE's operation.

In some examples, the processing circuitry 130 is configured to instantiate the TTE, that is generate an instance of the TEE (based on the TEE architecture). The instance of the TEE architecture may be referred to as a TEE. The TEE may use its components to enable the secure and isolated execution of workloads, such as the training of the machine learning model with the data. This includes computational activities that utilize the TEE's resources, including CPU, memory, and storage, to perform their operations. The TEE secures a training of the machine learning model against unauthorized access. For example, the TEE ensures that training of the machine learning model is protected from unauthorized access and/or tampering by leveraging the above-described security features. These features may include executing sensitive workloads in the isolated environment using the secure processing circuitry, storing sensitive data in the protected memory regions, and/or encrypting memory contents to safeguard data even in the event of physical access. For example, the TEE may utilize secure input/output operations to prevent data leakage during communication between the processing circuitry and peripheral devices. The secure storage capabilities of the TEE, such as dedicated partitions for cryptographic keys and configuration data, further ensure the integrity and confidentiality of critical information. In some instances, the TEE may employ tamper-resistant storage components to securely store integrity measurements and critical data, thereby protecting the training process and its associated data throughout its lifecycle. In some examples, the trusted execution environment may be an Intel® TDX trusted domain or an Intel® SGX enclave. The trusted domain may be considered as an instance of the TDX. The enclave may be considered as an instance of the SGX.

In some examples, instantiating the TEE may comprise generating attestation evidence of the TEE. This attestation evidence may include cryptographic measurements of the TEE's initial state, such as the integrity of the firmware, hardware configuration, and loaded software components etc. For example, a verifier, such as an external entity or service, may use this attestation evidence to ensure that the TEE has been correctly instantiated and is operating in a secure state before allowing sensitive data or workloads to be processed within the TEE. The verifier may verify the attestation evidence against known trusted values or signatures to confirm the integrity and authenticity of the TEE, thereby providing assurance that the TEE has not been compromised and is suitable for executing confidential operations.

The machine learning model may be a mathematical representation or algorithm designed to learn patterns from data and make predictions and/or decisions without being explicitly programmed for a specific task. The trained machine learning model may take in data, processes it, and generates outputs based on patterns it identifies. The of machine learning model may be for example any of the following: a decision tree, a support vector machine (SVMs), a regression model, a Bayesian model, an artificial neural network (ANNs), etc. In particular, it may be an ANN-based machine learning model, which may be any of the following: a feedforward neural network (FNN), a convolutional neural network (CNN) for example for image recognition tasks, a recurrent neural network (RNN) and/or long short-term memory network (LSTM) for example for sequence-based tasks like time-series forecasting or natural language processing, a transformer network for example comprising an attention mechanism (such as ChatGPT etc.), a generative adversarial network (GANs) for example for generating synthetic data or images, and an autoencoder for example for unsupervised learning and data compression.

The obtained data for training the machine learning model may comprise one or more training samples for the machine learning model. In some examples, the obtained data may comprise one or more images, one or more videos, one or more audio samples and/or one or more text data, such as source code, documents, transcripts etc.

For example, the machine learning model and/or the data may be obtained by the processing circuitry 130 via the interface circuitry 120. For example, the machine learning model and/or the data may be obtained by the processing circuitry 130 via the interface circuitry 120 from the storage circuitry 140. For example, the processing circuitry 130 is configured to obtain the data from a first party and the machine learning model from a second party. For example, the first party may be the owner of the data or an administrator responsible for managing the data. For instance, the second party may be the developer, owner and/or an administrator of the machine learning model.

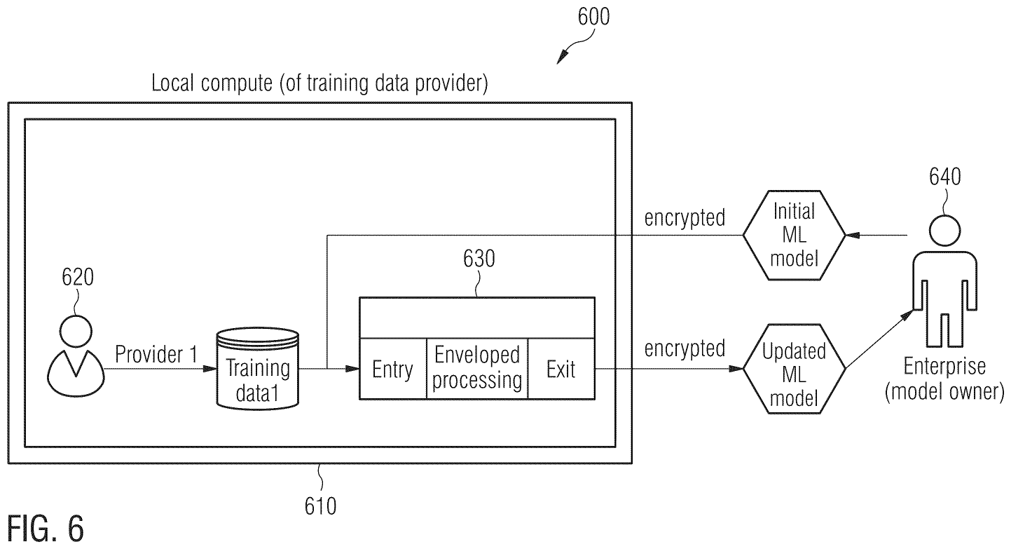

In some examples, the apparatus 100 may be under the control of the first party. For example, the processing circuitry 130 may obtain the data from the first party via the interface circuitry 120 from the storage circuitry 120 or via an/or internal network controlled by the first party. For example, the processing circuitry 130 may obtain the machine learning model from the second party via the interface circuitry 120 from an external source and/or network. For example, in this case the machine learning model may be encrypted to ensure secure transmission to the processing circuitry 130 (see also FIG. 6 below). For example, the processing circuitry 130 may be configured to decrypt the machine learning model after obtaining it and before training the machine learning model. For example, the processing circuitry 130 may be configured to encrypt the trained machine learning model before outputting it, for example to the second party.

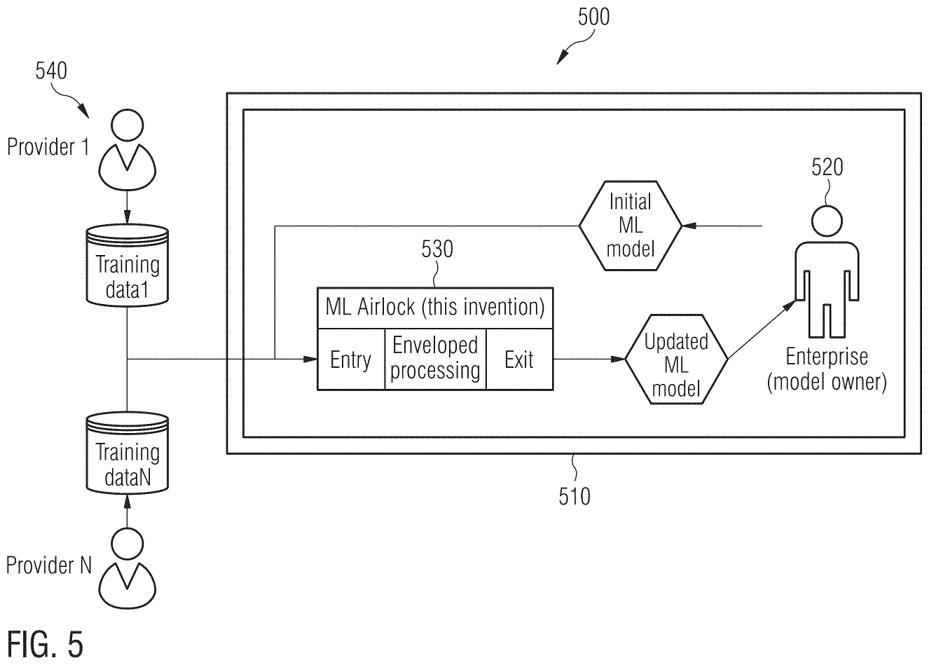

In some examples, the apparatus 100 may be under the control of the second party. For example, the processing circuitry 130 may obtain the data from the first party via the interface circuitry 120 from an external source and/or network. For example, the processing circuitry 130 may obtain the machine learning model from the second party via the interface circuitry 120 from the storage circuitry 120 and/or via an internal network controlled by the first party. For example, in this case the data may be encrypted to ensure secure transmission to the processing circuitry 130 (see also FIG. 5 below). For example, the processing circuitry 130 may be configured to decrypt the data after obtaining it and before training the machine learning model with the data.

In some examples, the apparatus may be under the control of a third-party, which may be neither the first party nor the second party configured to securely store and/or provide. For example, the third party may be a trusted escrow, and intermediary, a verification service and/or an administrator responsible for ensuring secure training of the machine learning model and secure obtaining and transmission of the data and/or machine learning model. For example, in this case the machine learning model may be encrypted to ensure secure transmission to the processing circuitry 130. For example, the processing circuitry 130 may be configured to decrypt the machine learning model and the data after obtaining before training the machine learning model with the data. For example, the processing circuitry 130 may be configured to encrypt the trained machine learning model before outputting it, for example to the second party.

For example, the processing circuitry 130 may be further configured to decrypt the machine learning model and/or the data with a private key of a private-public key pair. The machine learning model and/or the data may be encrypted with a corresponding public key. If for example, the machine learning model and/or the data may be transmitted to the processing circuitry 130 via a potentially unsecure path the machine learning model and/or the data may be encrypted. As described above this may be the case for the machine learning model if the apparatus 100 is under the control of the first party, or for the data if the apparatus 100 is under the control of the second party, or for the machine learning model and the data if the apparatus 100 is under the control of the third party. For example, the processing circuitry 130 may be further configured to generate, inside the TEE, the public-private key pair. For example, the processing circuitry 130 may publish the public key, which may be cryptographically bound to the TEE's attestation evidence (for example, so that a remote party may establish trust to said public key by the means of appraising the TEE status). The machine learning model and/or the data may be encrypted via the published public key. When the processing circuitry 130 obtains the encrypted machine learning model and/or data it may decrypt it with its private key.

In some examples, the processing circuitry 130 may be configured to encrypt the trained machine learning before outputting it. The processing circuitry 130 may transmit the encrypted machine learning model and with a corresponding key to decrypt it to an authorized party, for example, the second party.

The processing circuitry 130 is configured to verify at least one of the machine learning model and the data. Verification of the machine learning model and/or the data may comprise to perform one or more verification checks on the machine learning model and/or the data to ensure that the machine learning model and/or the data meet predefined criteria for example, for integrity, authenticity, and/or quality before being used in the training process. Verification may be considered successful when the machine learning model and/or the data meet some or all of the necessary criteria and pass the defined verification checks. This may ensure that the machine learning model is confirmed to be authentic, unaltered, and/or safe to use, and the data is deemed to be of sufficient quality and free from malicious intent. Conversely, for verification may for example deemed to be not successful (i.e., to have failed) if the model and/or the data does not pass one or more of the performed verification checks (also see below).

The processing circuitry 130 is to perform training of the machine learning model based on the data, if the verification of the at least one of the data and the machine learning model is successful. For example, if some or all of the performed verification checks on the machine learning model and/or the data are successful the training of the machine learning model based on the data is performed. Otherwise, the training may not be started. Training the machine learning model may involve feeding it the data (also referred to as training data) and allowing it to adjust its internal parameters, such as weights in the case of an artificial neural network (ANN), to improve its accuracy over time. The training process may vary depending on the type of machine learning model. There may be different types of learning, such as supervised learning, unsupervised learning, reinforcement learning, and semi-supervised learnin. In supervised learning, the machine learning model is provided with labeled data (input-output pairs), and it learns to map inputs to the correct outputs by minimizing the difference between its predictions and the actual outputs. In unsupervised learning, the machine learning model is given unlabeled data and must find patterns or structure within the data, such as grouping similar data points together or identifying anomalies. Training the machine learning model may involve using algorithms like gradient descent to iteratively adjust the model's parameters (such as weights in the case of an ANN) to optimize performance, typically measured by metrics like accuracy, loss, or precision. Depending on the quality of the training data, the trained model's ability may be improved to varying degrees. If for example, the training data is of very poor quality (for example if it is degraded, see below), the trained machine learning model's ability may even deteriorate significantly, for example leading to incorrect or unreliable outputs.

The processing circuitry 130 is configured to verify the training process of the machine learning model. Verification of the training process may comprise performing one or more verification checks during or after the training to ensure that the training process is conducted correctly and securely. This may comprise evaluating the consistency and validity of the training outcomes, such as comparing the performance of the trained model against predefined metrics or reference data. Verification of the training process may be considered successful when the trained model exhibits expected behavior and performance and/or the training process was performed without detecting anomalies and/or tampering. Conversely, verification may be for example deemed not successful if the training process results in unexpected behavior, such as unusual patterns in the model's outputs, and/or if discrepancies are detected in the monitored data, which may suggest tampering, data poisoning, and/or other issues affecting the integrity of the training (also see below).

The processing circuitry 130 is configured to output the trained machine learning model from the trusted execution environment, if the verification of the training process is successful. This ensures that the machine learning model may be released from the secure TEE once it has passed some or all of the training process verification checks. The trained machine learning model may be output to an authorized entity such as the second party (such as the model owner), a deployment platform, and/or a designated storage location, where it can be further utilized or integrated into applications, depending on the predefined usage policies and permissions associated with the machine learning model.

The structure of the above described technique mirrors the concept of an airlock. Just like an airlock ensures that only verified entities can pass through a controlled environment without compromising its integrity, the above described technique ensures that only secure and validated data and/or machine learning models are allowed into the training process within the TEE. The above described technique may be referred to as a machine learning model training airlock technique. The machine learning model and/or the data undergo a verification process to ensure their integrity, authenticity, and quality. If this verification is successful, the training process proceeds within the TEE. After the training is completed, the trained model is subjected to another round of verification to confirm that the training process was conducted securely and without tampering. Only when this second verification is successful is the trained model released from the TEE. This airlock-like structure of the above described technique may establish multiple security checkpoints that must be passed before the machine learning model may be used outside the secure TEE. This layered approach minimizes the risk of malicious code or data entering the training process, reduces the likelihood of tampering during training, and ensures that only a verified, trustworthy trained machine learning model is made available after training. It provides a robust mechanism for maintaining the integrity and security of both the training process and the resulting model, thereby enhancing the overall trustworthiness and reliability of the system.

Further, the above described technique ensures comprehensive security throughout the entire lifecycle of the machine learning model, from data and model verification to training and final output. Unlike existing approaches that may rely on external trusted entities or neutral platforms for secure training, the above described technique may integrate all verification and training steps within the secure boundaries of the TEE. This may eliminate the need for third-party arbitration and reduces potential vulnerabilities associated with transferring data and models between different environments. By using the airlock approach as described above, where multiple layers of verification are applied both before and after training, the above-described technique provides a self-contained and highly secure framework that mitigates risks associated with unauthorized access, data poisoning, and side-channel attacks, which are common concerns in traditional machine learning systems.

### Side Channel Leakage

In some examples, the processing circuitry 130 may be further configured to reduce a side-channel leakage emitted by the machine learning model during the training process of the machine learning model. The side-channel leakage may refer to an unintended release of information from one or more components of the computing system which is performing the training of the machine learning model through indirect channels. The side channel leakage may occur from different components such as machine learning model, the TEE, or the host system executing the TEE (such as the apparatus 100). The side channel emissions may be not part of the normal data flow but may be physical or behavioral byproducts of the computational processes. The side-channel emissions may comprise variations in power consumption from the host system during intensive computations, which may reveal the nature of the operations being performed. In another example, timing differences in the execution of the machine learning model may leak information about the data being processed, such as input characteristics or model parameters. Electromagnetic emissions from the host system executing the TEE may also serve as a source of leakage, where the signals captured from the hardware components can be analyzed to infer the TEE's internal states or the nature of the training data. Further, cache access patterns within the host system's CPU may reveal which data is being accessed and used during the training, providing potential insight into the model's structure or the input data characteristics. Attackers may exploit these side channel emissions to infer sensitive information about the data being processed, the operations being performed, or even the internal state of the system. For example, an attacker may analyze variations in power consumption by measuring power usage over time and correlating it with specific operations, such as encryption or model training steps, to deduce the type of data being processed or the nature of the computations. Similarly, by measuring and analyzing timing differences, an attacker may determine if the model is performing certain operations more frequently, which could indicate specific input data characteristics or even reveal the structure of the model itself. Electromagnetic emissions may be captured using specialized equipment to monitor the signals emitted by the host system, allowing an attacker to reconstruct the sequence of operations being executed within the TEE, potentially exposing the nature of the data or the computation being performed. Further, an attacker may monitor cache access patterns using side-channel techniques like cache-timing attacks to identify which parts of the memory are being accessed, thereby gaining insight into the data being processed or the specific functions the model is executing

Reducing the side-channel leakage emitted during the training of the machine learning model may be based on monitored side-channel emissions. The monitored side-channel emissions of the TEE may refer to the observed patterns and signals related to the TEE's internal operations, such as variations in execution timing, power consumption, or memory access within the secure environment. The monitored side-channel emissions of the host system may refer to the signals and patterns generated by the broader system hosting the TEE, including overall system power usage, thermal outputs, and interactions between the TEE and other system components. Based on these monitored emissions, the processing circuitry 130 may dynamically adjust the training process or system behavior/TEE behavior to obscure or alter the detectable patterns in the side-channel emissions, thereby reducing the risk of an attacker deducing sensitive information from the leaked data.

In some examples, it may be difficult to completely prevent any side channel leakage at the source, i.e., at the machine learning model, because the machine learning model may be obtained by the processing circuitry 130 without having the possibility to access the internal configuration or source code of the machine learning models itself, therefore, the reducing of the side channel leakage may be performed.

In some examples, to reduce a side-channel leakage of the trusted execution environment may comprise adding noise to the TEE operations and/or to the training process during the training of the machine learning model. Adding noise may refer to introducing randomness or variability into the operations of a system to obscure predictable patterns, making it more difficult for an attacker to analyze or exploit side-channel emissions. Adding noise to the TEE operations during the training process may refer to introducing random variations in the execution of instructions or system resource usage, such as ensuring that each computational task takes a consistent amount of time, regardless of the training data input, to counteract timing-based side-channel attacks. If the side-channel emissions are observed at the host system level, such as performance telemetry, noise may be added by introducing spurious resource usage to disrupt the system's operational patterns. Adding noise to the training process operations during the training process may refer to altering the internal computations of the machine learning model, such as randomizing memory access patterns or injecting variability into the processing of data inputs to disrupt predictable behavior patterns that could be observed and exploited by an attacker. For example, if the leakage involves heat or electromagnetic emissions, noise may be added at the hardware level to obscure these emissions, preventing attackers from inferring sensitive data based on physical signal analysis.

The adding of noise may prevent side-channel attacks by altering the detectable signals, such as timing or power consumption, which are byproducts of the training process. The noise may be added at different levels. That means noise can be injected into specific components, such as the TEE or the machine learning model itself, or at a broader system level, such as the host system supporting the TEE. Depending on where the leakage is observed, these targeted or system-wide interventions can effectively mask the information being leaked, thereby reducing the risk of an attacker deducing sensitive data from the side-channel emissions. By dynamically adding noise to the relevant components, the system ensures robust protection against a variety of side-channel attacks, maintaining the security and confidentiality of the training process.

In some examples, the processing circuitry 130 may be further configured to monitor the side channel emissions of TEE. That is monitoring of side-channel emissions from the TEE by the processing circuitry 130 may be performed by continuously observing various physical and operational metrics, such as power consumption, timing information, and electromagnetic signals, which are byproducts of the TEE's operations. Specialized sensors or software tools within the host system (such as the apparatus 100) may be used to capture these emissions in real time. For example, power monitoring tools may track fluctuations in power usage, while timing analysis software can detect variations in execution times of certain processes. Electromagnetic sensors can capture signals emitted from hardware components, providing insights into the activities within the TEE. By collecting and analyzing these emissions, the system can detect unusual patterns or anomalies that may indicate potential side-channel vulnerabilities, allowing for timely implementation of countermeasures to secure the sensitive data and operations within the TEE.

In some examples, the to reduce a side-channel leakage of the trusted execution environment comprises at least one of the following: introducing a random delay during the training of the machine learning model, introducing additional resource usage into the training of the machine learning model, interrupting the training of the machine learning model at random intervals, randomizing code execution paths, and randomizing memory access patterns during the training of the machine learning model. Introducing a random delay during the training of the machine learning model may comprise adding unpredictable pauses in the execution of training operations. By varying the time taken for certain processes, such as completing a training epoch (such that each training epoch takes the same amount of time, regardless of training data input) or performing calculations, the processing circuitry 130 obscures consistent timing patterns that could otherwise be used by attackers to infer information based on the duration of specific operations. This approach makes it significantly harder for an attacker to perform timing-based side-channel attacks, as the timing information becomes unreliable and unpredictable.

For example, by injecting random delays during execution of instructions, altering power consumption by running additional computations, or generating random traffic on the system bus one may obscure memory access patterns. For timing-based side-channel attacks, random or deterministic delays can be added to specific operations, such as function calls or memory access, making it difficult for attackers to deduce the exact timing of operations. For power analysis attacks, noise can be introduced by executing power-hungry instructions that alter the power profile of the system, masking the power consumption patterns of sensitive operations. In the case of electromagnetic or acoustic emissions, additional instructions can be run concurrently to increase background noise, making it more challenging to isolate and analyze the emissions related to sensitive data processing. Additionally, noise can be injected at different levels of the execution environment, such as the runtime, hypervisor, or hardware layer, ensuring comprehensive protection against various attack vectors. For example, the noise injector may activate a noise injection mode in the runtime environment to execute pre-defined sets of instructions that increase power consumption or heat emission, or it may engage a hardware-based mechanism to generate electromagnetic noise. These techniques collectively disrupt the signal-to-noise ratio of potential side-channel leaks, making it significantly more difficult for an attacker to extract useful information from the observed signals (also described in the Patent Application by Intel (application Ser. No. 18/307,214): “Apparatuses, Methods and Computer Programs for Executing an Executable, and Method for Distributing Software or Firmware”).

Introducing additional resource usage during the training of the machine learning model may comprise consuming extra CPU, memory, and/or power resources that do not correspond directly to the actual training operations, thereby creating a noisy and misleading resource usage profile. This may prevent attackers from accurately analyzing and extracting information based on observed resource consumption patterns.

Interrupting the training of the machine learning model at random intervals may comprise disrupting the regular flow of operations. By unpredictably pausing or breaking the training process, the processing circuitry 130 may prevent attackers from correlating observed signals with specific training steps or data inputs, thus complicating their attempts to deduce sensitive information.

Randomizing code execution paths may refer to varying the sequence of instructions or computational steps executed during the training process. By changing the order in which code blocks are executed or using alternative algorithms unpredictably, the processing circuitry 130 may prevent attackers from recognizing or predicting which parts of the code are being processed. This may make it difficult for them to map side-channel emissions to specific code execution, reducing the chances of a successful attack.

Randomizing memory access patterns during the training of the machine learning model may comprise altering the order and timing of data retrieval and storage in memory. This may disrupt consistent memory access patterns, making it challenging for attackers to use techniques such as cache-timing attacks to infer which data is being processed or to gather information about the model's structure or the input data

In some examples, the processing circuitry 130 may be further configured to monitor the side channel emissions of TEE.

Verification of the Training Process, the Machine Learning Model and/or the Data

In some examples, to verify the training process of the machine learning model may comprise performing a statistical test based on the input data and the trained machine learning model. For example, this may involve conducting a correlation test between the input data and the trained model. For example, the correlation test may detect whether the model is attempting to encode sensitive information from the input data into its weights or parameters. For example, if a model is designed to memorize and encode specific input data directly into its weights, this encoded information may be used to reconstruct the original data against the will of the data owner. Verification of the training process may be successful if the statistical test shows no significant correlation (for example below a pre-determined threshold) between specific sensitive data points and the model's weights, indicating that the model has not memorized or embedded the input data in a way that could compromise data security. Conversely, verification may be unsuccessful if the test reveals a high correlation (above a pre-determined threshold) between particular data points and certain patterns in the model's weights, suggesting that sensitive information has been embedded. For example, a successful verification may show that random fluctuations in the input data do not result in systematic changes in the weights. However, if the test finds that certain identifiable features from the input data, such as personal identifiers or confidential numerical values, correspond directly to specific changes in the model's weights, this may indicate an attempt to exfiltrate the data. Specific examples of correlation tests include Pearson's correlation coefficient, which measures the linear relationship between variables, and mutual information, which quantifies the amount of shared information between the input data and the weights. For instance, if Pearson's correlation coefficient between a sensitive feature and a set of weights is close to zero, the verification may be successful. However, if the coefficient is significantly positive or negative, indicating a strong linear relationship, the verification would fail, suggesting that the model may be malicious.

In some examples, to verify the training process of the machine learning model may comprise performing a statistical test based on monitored telemetry data during the training process of the machine learning model and reference telemetry data of the training process. For example, the telemetry data, such as CPU usage, memory consumption, and timing information, collected during the training process may be used to validate the training's integrity. For example, by comparing the monitored telemetry data with reference telemetry data, the processing circuitry may detect unusual patterns or deviations that might indicate tampering or irregularities in the training process. Verification of the training process may be successful if the monitored telemetry closely matches the reference data, suggesting that the training process has been executed correctly. For example, verification of the training process may be successful if the monitored telemetry overlaps or correlates with the reference data above a pre-determined threshold. If discrepancies are detected, it may suggest potential threats such as side-channel attacks or malicious interference, resulting in a failed verification. For example, a failed verification may occur if the CPU usage spikes significantly higher than expected during specific training phases, indicating potential data manipulation, or if memory access patterns differ from the reference, suggesting that the model is accessing unauthorized data locations and/or attempting to actively emit sensitive information through a side-channel. Similarly, if timing information shows abnormal delays or accelerations during the execution of certain tasks, it may indicate that malicious code has altered the model's behavior, resulting in a failed verification.

In some examples, the apparatus of claim 8, wherein to verify the training process of the machine learning model comprises to perform a self-test training of the machine learning model, the self-test being based on training the machine learning model with controlled test data. This claim involves running a self-test using controlled test data, specifically designed to validate the integrity and functionality of the training process. The self-test training ensures that the model behaves as expected when exposed to known input data, allowing the system to identify any deviations or abnormal responses. Verification is considered successful if the model's performance on the self-test data matches the expected outcomes, indicating that the training process was not compromised. If the model fails to perform as expected, this may indicate issues such as tampering, improper training, or the presence of malicious components, resulting in a failed verification.

In some examples, to verify the data may comprise at least one of the following: assessing the quantity of the data, analyzing the data for anomalies, assessing if a predetermined payment amount for using the data has been made, and assessing whether the data is malicious. Assessing the quantity of the data may comprise ensuring that there is a sufficient amount of data available to effectively train the machine learning model. For example, this may involve checking that the dataset contains enough samples to adequately represent the target domain and that it meets or exceeds a predefined minimum sample size required for effective training. Verification may be successful if the quantity of data meets or exceeds a predetermined threshold, indicating that there is sufficient data to support robust training and prevent issues such as overfitting or underfitting. If the data quantity is below the threshold, verification may be unsuccessful, as this could lead to inadequate model performance or biased training outcomes. Analyzing the data for anomalies may comprise statistical tests to detect outliers or inconsistencies that deviate significantly from expected patterns, which could indicate data corruption or intentional tampering. In some examples, the expected patterns may be established by the processing circuitry 130, by comparing similar datasets from a variety of providers (for example, these similar datasets from a variety of providers may not be accessible in the cleartext to the machine learning model owner, but are visible to the ‘airlock’, that is the processing circuitry 130, itself). For example, this may include calculating z-scores or using clustering techniques to identify data points that fall outside of the normal distribution. Verification may be successful if no significant anomalies are detected, suggesting that the data is consistent and reliable for training purposes. If anomalies such as outliers or unusual patterns are found, this may indicate potential data poisoning or manipulation, resulting in a failed verification. For example, telemetry information may be used—such as power consumption, temperature, and computing cycles—to create a profile of expected behavior for the machine learning model training running on particular hardware. The trusted profile may be generated from a known, secure environment, such as an end-user platform, and is used as a reference to compare against telemetry data collected from the model's execution on a third-party service provider's resources, such as a cloud service provider (CSP). In some examples, the trusted profile may be generated captured during prior executions of the same machine learning model in this (or another) instance of the airlock component and stored in a tamper-resilient location (for example a distributed ledger). Any deviations or anomalies in the telemetry data, such as unexpected power usage or processing times, may indicate that the model has been tampered with, substituted, or executed incorrectly. If the telemetry data from the CSP matches the trusted profile within an acceptable error margin, it suggests that the machine learning model training was legitimate and compliant with the intended configuration, ensuring that the correct machine learning model and data were used during inference. Conversely, if significant discrepancies are detected, it may indicate unauthorized actions, such as model substitution or misuse of computational resources, prompting the system to deny payment authorization or trigger additional security measures (also described in the patent application by Intel “Methods, systems, articles of manufacture and apparatus to verify integrity of model execution on computing resources using telemetry information”).

Assessing if a predetermined payment amount for using the data has been made comprises verifying that the agreed-upon fee or compensation for accessing and using the data has been fulfilled according to contractual terms or data usage policies. For example, this may involve checking a payment ledger or transaction record to ensure compliance with the financial agreements associated with the data. Verification may be successful if the payment has been confirmed, indicating that the data usage is authorized. If the payment has not been made or does not match the agreed-upon amount, the verification would fail, preventing the data from being used in training.

Assessing whether the data is malicious may comprise evaluating whether the data is specifically curated to negatively impact the machine learning model, such as attempting to produce biased or false results. This may involve checking for known patterns of malicious data, such as repetitive or contradictory entries designed to mislead the model, or running statistical tests to identify abnormal distributions. Verification may be successful if the data shows no signs of being curated to mislead or harm the model, indicating that the data is trustworthy. Conversely, if the data is found to contain suspicious patterns or characteristics, such as an unusually high concentration of similar values or features that significantly deviate from previous datasets, verification may be unsuccessful, and the data may be flagged as malicious, preventing its use in training to ensure the model's integrity.

In some examples to verify the machine learning model may comprise to verify an origin of the machine learning model. This may comprise confirming that the model comes from a legitimate and trusted source and has not been altered or tampered with. Verification of the origin may comprise checking a provenance certificate associated with the model, verifying the identity of the vendor or developer, and/or cross-referencing the model's unique ID or fingerprint with a trusted distributed ledger or a trusted authority. This may ensure that the model has been created and provided by a known and reliable entity and has not been modified for malicious purposes, such as embedding hidden backdoors or exfiltrating sensitive data. Verification may be successful if the origin of the model matches the expected criteria, such as the model's unique ID corresponding to a verified entry in a trusted ledger, indicating that the model is authentic and safe to use. Conversely, verification may be unsuccessful if the origin cannot be verified, such as when the model's provenance certificate is missing or the model's unique ID does not match any known entries in the trusted ledger, suggesting the model may have been tampered with or sourced from an untrustworthy entity. For example, successful verification may involve confirming that the model has been issued by a trusted organization for a specific non-profit purpose, ensuring it is not used for unauthorized commercial activities or other unintended purposes, thus maintaining the integrity and trustworthiness of the training process. For example, the specific data may be provided only to participate in a non-profit cancer research project, but may be not to commercial pharmaceuticals development.

In some examples, the verification of the machine learning model may not be successful if the machine learning model is assessed as being malicious. This means that if the model exhibits any behavior or characteristics that indicate malicious intent, the verification process will fail. In some examples, the machine learning model may be assessed as being malicious if at least one of the following applies: the machine learning model attempts to de-anonymize data, the machine learning model attempts to exfiltrate raw data, the machine learning model uses the training data beyond an allowed purpose, and the machine learning model operates without available consent. The machine learning model may attempt to de-anonymize data by trying to reconstruct or infer the identities of individuals from anonymized data points, such as by correlating anonymized data features with external data sets or using specific algorithms to reverse the anonymization process. The machine learning model may attempt to exfiltrate raw data by embedding parts of the input data into its outputs or weights (for example, outputting through purposefully-created side-channel emissions), enabling unauthorized parties to reconstruct or access sensitive information without direct access to the training data. The machine learning model may use the training data beyond an allowed purpose by retaining the data for additional training rounds or tasks not originally authorized, such as using medical data meant for research purposes in a commercial application or continuing to use data after consent has been withdrawn or expired. The machine learning model may operate without available consent by processing or accessing data for which it does not have permission, such as utilizing personal data without explicit user consent or breaching data usage policies by using the data in ways that go beyond the agreed terms.

In some examples, the verification of the machine learning model may be successful if the data comprises at least a first predetermined number of distinct data sets. Each of the distinct data sets may have a size of at least a second predetermined number of samples and/or may originate from a different provider. This may ensure that the training data used for the machine learning model is sufficiently diverse and robust. Further, it may ensure that no conclusions can be drawn about individual data sets due to an insufficient number of contributing sets. For example, if a hospital provides cancer research data to an insurance company that intends to use it for training their machine learning model, the hospital may want to ensure that the insurance company can only train their model if at least five other hospitals also provide their data for training. This would give the hospital reasonable assurance that the insurance company cannot draw conclusions from the trained model about whether the hospital's data is above or below average. Verification may be successful if there are a minimum number of distinct data sets, each meeting a specified size requirement and originating from different sources. This diversity helps prevent overfitting and reduces bias in the model, thereby enhancing its generalizability and fairness. For instance, successful verification may occur if the data comprises at least five distinct data sets, each containing no fewer than one million samples, sourced independently from various hospitals. Conversely, verification may be unsuccessful if the data does not meet these criteria, such as if there are fewer than the required number of distinct data sets or if the data sets do not meet the size threshold, indicating a lack of diversity or potential bias in the training process. This could compromise the reliability and fairness of the model, as it might over-represent or under-represent particular data source.

In some examples, the processing circuitry 130 may be further configured to degrade or improve the data based on the payment amount made for using the data in training a machine learning model. The degradation of data may refer to intentional modifications that lower its quality or integrity, such as mislabeling samples, introducing subtle errors, or altering features to cause the machine learning model to learn incorrect patterns. This process is may also be referred to as data poisoning. For example, if the input data comprises numeric samples with 10 digits of precision, lower payment tiers may provide data with reduced precision, such as rounding values to only 7 digits, or removing specific features entirely, which diminishes the effectiveness of the data in training the model. This ensures that unauthorized users or those who have not paid the full amount receive data of reduced quality, thereby preventing misuse and protecting the data owner's interests. Conversely, improving the data quality may involve reversing such degradation or restoring the data to its full precision and feature set based on a higher payment amount. For example, the processing circuitry 130 may be configured to receive degraded data and verify if the required payment has been made. If the payment amount meets or exceeds a predetermined threshold, the processing circuitry 130 may then restore the degraded data, such as by providing the original precision or reinstating stripped features, thus enhancing the data quality for authorized users. For example, the processing circuitry 130 may be configured to receive non-degraded data and verify if the required payment has been made. If the payment amount does not meet a predetermined threshold, the processing circuitry 130 may then degrade the data. This dynamic adjustment of data fidelity based on payment ensures that access to high-quality, accurate data is controlled and monetized according to the data owner's terms. For instance, in cases where the original data includes images with detailed metadata, lower payment tiers might exclude this metadata, while higher payment tiers would restore it, allowing the model to benefit from the additional context. Similarly, in the case of text data such as source code, degraded data may include obfuscated or truncated functions, which can be restored to their full, usable form when the appropriate payment is confirmed. This approach not only deters unauthorized use but also allows data owners to offer a tiered data access model, where users receive data quality that corresponds to the value of their investment (this is also disclosed in the Intel patent application named “An apparatus for generating metadata, an apparatus for examining metadata and an apparatus for storing metadata”, filed on Oct. 21, 2024, by the inventors Mateusz Bronk, Arkadiusz Berent, Piotr Zmijewski, Krystian Matusiewicz).

In some examples, the processing circuitry 130 may be further configured to anonymize the data before using it for training the machine learning model. Data sample anonymization may be performed before training the machine learning model with the data. It may comprise modifying the data to remove or obscure identifying information that could potentially reveal the identity of individuals or entities represented in the dataset. This process may ensure compliance with privacy regulations and protects sensitive information from being inadvertently exposed during the training process. For example, anonymization may involve removing or replacing personal identifiers, such as names or social security numbers, with pseudonyms, generalizing specific data points (e.g., converting exact ages to age ranges), or adding statistical noise to certain features to prevent re-identification. Verification of the anonymization process may be successful if the data meets predefined criteria for anonymity, such as ensuring that no single data point can be linked back to an individual or entity with high confidence. Conversely, verification may be unsuccessful if the data retains unique patterns or identifiers that could be used to re-identify the individuals or entities represented, indicating that the anonymization is insufficient. For instance, if the processing circuitry detects that an individual's unique medical history is still distinguishable in the data after anonymization, the process would fail verification, and the data would not be used for training. In such cases, further anonymization or data masking techniques would be applied until the data meets the required anonymity standards, ensuring that privacy is maintained throughout the training process.

In some examples, the processing circuitry 130 may be further configured to generate a first certificate. The first certificate may comprise an indication that the data was used to train the trained machine learning model. This certificate may serve as proof for the data owner that their data has been utilized in the development of the machine learning model as intended. It may include details such as the origin of the data, the scope of its use, and the specific conditions under which it was employed during training. The first certificate may help maintain transparency and accountability, especially in scenarios involving multiple data providers or stringent data usage policies. For instance, this certificate may be issued to data owners to confirm the legitimate use of their datasets and may be shared with regulatory bodies to demonstrate compliance with data handling regulations. By documenting and tracking the data usage, the first certificate provides confidence to all stakeholders that the data was employed in a secure and authorized manner during the training process, and it may also include confirmation of successful payment to the data owner for their contribution.

In some examples, the processing circuitry may be further configured to generate a second certificate. The second certificate may comprise an indication of the quality of the data used for training the machine learning model. It may be generated in addition to or instead of the first certificate. The second certificate, acting as a bill of materials (BOM). It may be used by the machine learning model owner and detail the composition and quality of the training data. It may include information such as data provenance, integrity, and any preprocessing or enhancements applied to the data before training. This certificate may ensure that stakeholders, including model users and regulatory bodies, have a clear understanding of the data's contributions and quality benchmarks, such as accuracy or completeness. It may also indicate if the data underwent anonymization or augmentation processes. By providing a detailed account of the training data's quality and characteristics, the second certificate helps establish trust and accountability in the development of the machine learning model and may also confirm successful payment by the model owner to the data providers for the data used in training, ensuring that the model development process is transparent and ethically managed.

In some examples, the processing circuitry 130 may be further configured to perform a payment of a pre-determined payment amount to a payment address for using the data. For example, the payment may be performed before and/or after training the machine learning model with the data. Upon completion of the training process, the processing circuitry 130 may initiate a payment to the data provider's designated payment address. This payment may correspond to a pre-agreed amount for the use of the data in training the model. The payment serves as compensation to the data owners for their contribution, and the transaction details may be documented in the first and/or second certificate. These certificates may include an indication of the successful payment, linking the financial transaction to the data usage, thereby providing a transparent record of the data's utilization and the associated compensation. This mechanism not only ensures that data providers receive their due compensation but also establishes a verifiable link between data usage and payment, which can be essential for compliance and audit purposes. For example, a data provider might receive a certificate stating that their dataset was used to train a machine learning model, and that the corresponding payment has been made to their specified payment address, confirming that the terms of data usage and compensation have been fulfilled. For example, the payment amount may influence the quality of the data used for training, as described above. If the data provider receives the full payment, the data may be used in its original, high-quality form. Conversely, if the payment is lower than the agreed amount, the processing circuitry 130 may degrade the data. The payment status and the corresponding data quality may also be reflected in the generated certificates, such as the first or second certificate. For example, the certificate may indicate that the data was used in a degraded form due to partial payment, providing transparency and accountability in the data usage and compensation process. This dynamic adjustment of data quality based on payment further ensures that only authorized users who have fulfilled the required payment conditions can access and benefit from high-quality training data.

In some examples, the trained machine learning model may be input to the trusted execution environment together with second data. This may comprise using the trained model within the TEE to perform additional training or fine-tuning on one or more further data sets. The second data may comprise new or supplementary information that was not part of the initial training process, enabling the model to learn from a broader range of data and improve its accuracy or adapt to new patterns. This iterative training process may involve feeding the trained machine learning model back into the TEE along with the second data, creating a feedback loop where the model is continually refined and evaluated in a secure environment. The use of the TEE ensures that the retraining and evaluation of the model remain protected from unauthorized access or manipulation, safeguarding both the model and the sensitive second data during the training process. This approach allows for secure and controlled updates to the model, ensuring that it can evolve and improve over time while maintaining the integrity and confidentiality of the data used in each training iteration.

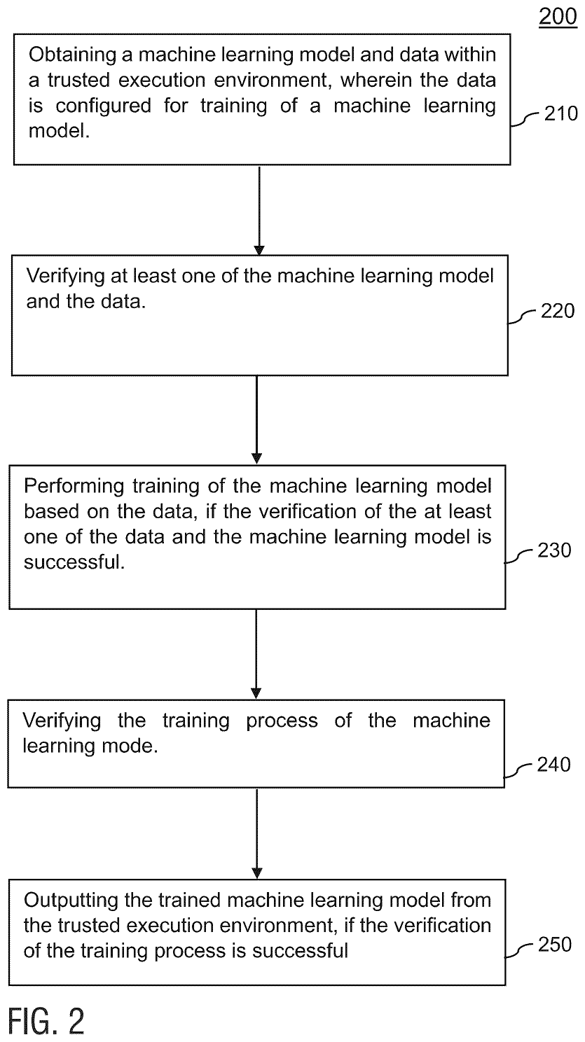

Further details and aspects are mentioned in connection with the examples described below. The example shown in FIG. 1 may include one or more optional additional features corresponding to one or more aspects mentioned in connection with the proposed concept or one or more examples described or below (e.g., FIGS. 2-6).

FIG. 2 illustrates a flowchart of an example of a method for secure machine learning model training 200. The method 200 may, for instance, be performed by an apparatus as described herein, such as apparatus 100. The method 200 comprises 210 obtaining a machine learning model and data within a trusted execution environment. The data is configured for training of the machine learning model. The trusted execution environment secures a training of machine model against unauthorized access. The method 200 may further comprise 220 verifying at least one of the machine learning model and the data. The method 200 may further comprise 230 performing training of the machine learning model based on the data, if the verification of the at least one of the data and the machine learning model is successful. The method 200 may further comprise 240 verifying the training process of the machine learning model. The method 200 may further comprise 250 outputting the trained machine learning model from the trusted execution environment, if the verification of the training process is successful

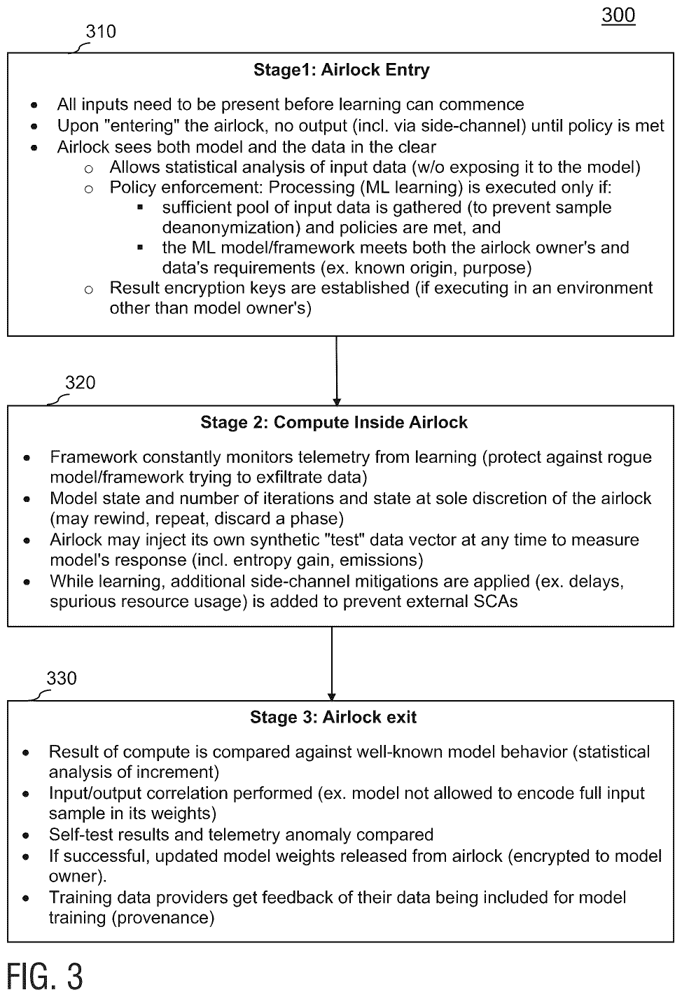

More details and aspects of the method 200 are explained in connection with the proposed technique or one or more examples described above (e.g., with reference to FIG. 1), or below. The method 200 may comprise one or more additional optional features corresponding to one or more aspects of the proposed technique, or one or more examples described above (e.g., FIG. 1) or below (e.g., FIGS. 3-6).

### Further Examples

FIG. 3 illustrates an example of a flow chart 300 of the proposed technique. As described above the proposed technique may be referred to as a machine learning model training airlock technique. The airlock in this example, may be implemented by a processing circuitry, such as the processing circuitry 130 and/or by a TEE. The first stage 310 may be referred to as the airlock entry stage. Similar as to an airlock, which may not equalize the pressure until its doors are shut, the proposed technique for machine learning model training, does not allow to commence the machine learning model training until all inputs are verified. This may comprise the training data and the machine learning model are available and meet their respective policies. In the first stage 310 all inputs may need to be present before learning can commence. Further, upon entering the airlock, no output is allowed (incl. via side-channel) until the policy is met (for example, between start of entry and until the exit). Further, in the first stage 310 the airlock sees both the machine learning model and the data in the clear. This may allow the airlock to perform statistical analysis of input data (without exposing it to the model). Further, this may comprise the policy enforcement. The policy enforcement may comprise the processing (machine model learning) is executed only if a sufficient pool of input data is gathered (to prevent sample deanonymization) and policies are met. Further, the policy enforcement may comprise the processing is executed only if the machine learning model meets both the airlock owner's and data's requirements (for example known origin, or purpose). Further, in the first stage 310 the airlock may generate result encryption keys (if executing in an environment other than model owner's).

In second stage 320 may be referred to the compute stage inside the airlock. In the second stage 320 the actual machine learning model training is executed, for example under full “airlock's” supervision. This may comprise not only controlling all of process's I/O, but also insulating the execution from outside world by actively deploying side-channel countermeasures. Further, the machine learning model training may be performed in a TEE to achieve such control and workload insulation, while allowing for remote attestation of airlock properties (making it a trusted third party). The second stage 320 may constantly monitor telemetry from learning (protect against rogue model/framework trying to exfiltrate data). Further, in the second stage 320 the model state and the number of iterations and the state may be at sole discretion of the airlock (may rewind, repeat, discard a phase). Further, in the second stage 320 the airlock may inject its own synthetic test data vector at any time to measure model's response (incl. entropy gain, emissions) (also referred to as performing a self-test). Further, in the second stage 320, during the training, additional side-channel mitigations may be applied (for example delays, spurious resource usage) to prevent external side channel attacks (SCAs).

In third stage 330 may be referred to as an airlock exit stage. Before a training result (for example updated model weights) may be released from the airlock (that is the TEE), the airlock may check whether the training process has been executed correctly (by running statistical tests of input/output correlation and analyzing telemetry profile during the learning). If the training process is considered legitimate, the airlock may dispense the result back to machine learning model owner and/or their delegate and the process may restart. The third stage 330 may comprise comparing the result of compute against a well-known model behavior (statistical analysis of increment). Further, the third stage 330 may comprise performing an input/output correlation (for example, the model not allowed to encode full input sample in its weights). Further, the third stage 330 may comprise compare self-test results and telemetry data to detect anomalies. Further, if the verification of the third stage 330 is successful, the updated machine learning model (weights) may be released from airlock (for example the model may be encrypted and transmitted to model owner). Further, in the third stage 330 the training data provider may receive feedback of his data being included for model training (provenance).

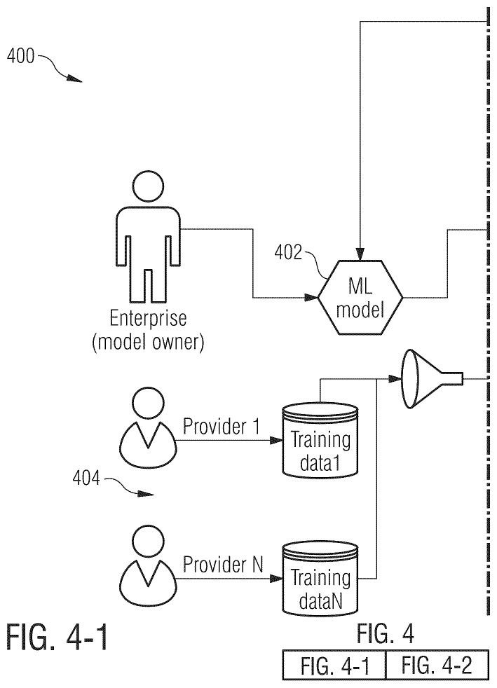

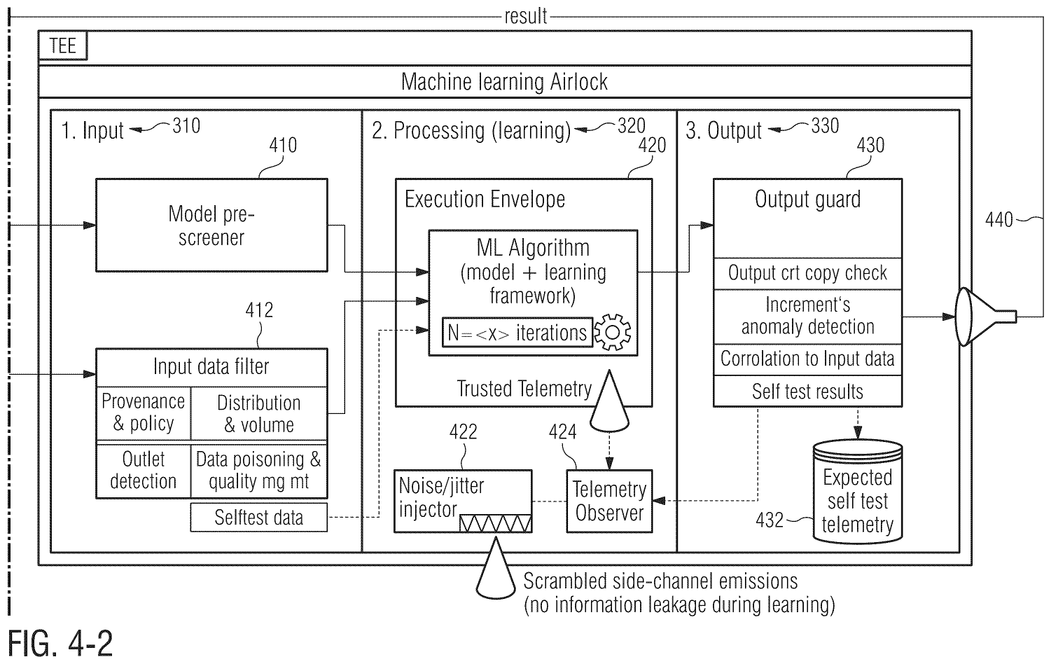

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-6).

FIG. 4 illustrates an example of a block diagram 400 of the proposed technique. The block diagram 400 shows the three stages 310, 320, 330 as described in FIG. 3. In the first stage a model pre-screener 410 and an input data filter 412 may be used. The model pre-screener 410 receives the machine learning model 402, for example from an enterprise which is the model owner. The machine learning mode may possibly be encrypted in a way that is only openable by the airlock. The pre-screener 410 is assessing the machine learning models properties such as provenance (vendor, source), purpose (ex. for-revenue, non-profit), community score/rating or internal composition for known good/bad patterns. This can be done using existing methods. In some examples, the pre-screener 410 may get the machine learning model's track of record based off previous execution (and good/bad) behavior while within the airlock itself. For example, the machine learning model, which is routinely known to try to exfiltrate user data or create abnormal resource usage etc., may have it incrementally harder to even enter the airlock in the future (esp. if all the airlocks share ‘crowd’ intelligence and scoring, ex. via a distributed ledger).

The input data filter 412 is tasked with assessing the quantity and quality of training data 404. The input data filter 412 may receive a plurality of training data 404 (1, . . . , N) which may be used to train the machine learning model 402 one after the other via the feedback loop 440. The input data filter may perform provenance and policies checks (for example has the machine learning model owner paid for the data, is the purpose allowed). Further, the input data filter 412 (given the airlock sees all the data in the clear, decrypted on entry), may defend against model poisoning (for example using the technique as described in “De-Pois: An Attack-Agnostic Defense against Data Poisoning Attacks”; Chen, Zhang, Zhang, Wang, Liu; 2021). Further the input data filter 412 may perform the following checks: It may ensure data quantity is sufficient not to deanonymize sample (for example, only allow the learning to commence if training data from minimum 3 distinct sources is available, do not allow the operator choosing data subsets). Further, the input data filter 412 may analyze data from different sources for statistical outliers and anomalies (for example, same feature set from five sources shows a certain correlation, but the 6th source having a fundamentally different profile even though origin is similar-possible attempt at model poisoning). The airlock may carry its own state, preserving expected training data characteristics over executions. Further, the input data filter 412 may perform quality assurance. That is if the input data is good (for example based on a certified origin), the airlock may issue (on exit) a provenance statement, certifying to the model only being trained on good dataset (ex. high quality, licensed, legal infringement-free, etc.). Further, the input data filter 412 perform a flexible quality/selective input degradation. That is the input data filter 412 may allow premium plans for training data usage (for example, VOD-like, pay for higher fidelity of data (or model, if used at inference-time)). For example, in case of a high-fidelity and curated training dataset created by a provider (for profit). Since not every machine learning model needs high fidelity data, in some training cases, the price for the dataset may not be justified. In such cases, the airlock allows to still use that data though (at a lower price), by introducing a ‘poisoning’ a component which can: add deliberate ‘noise’ (fuzz, ex. using Nightshade algorithm), anonymize (for example, using the technique as descried in “K-anonymity: A model for protecting privacy”; Sweeney; 2002), and/or strip certain features of the data samples. Further, if the training set is sensitive (or high value), it may further limit its wear (that is the number of iterations of learning that can be performed on it) or constrain the validity time window (data decay).

In the second stage an execution envelope 420, a noise injector 422 and/or a telemetry observer 420 may be used. The execution envelope 420 may be actual execution sandbox, where the machine learning model is trained (under full supervision of the airlock, that is it controls all its inputs and outputs and can start/stop/pause at its own discretion). For example, the execution envelope 420 may comprise a TEE. Further, the telemetry observer 424 may be trusted companion to the execution envelope (in some examples, non-separable from it), and may constantly monitoring the emissions from the machine learning model learning process for two purposes:
1) The trusted profile match/anomaly detection. Analyzing the data for anomalies may comprise statistical tests to detect outliers or inconsistencies that deviate significantly from expected patterns, which could indicate data corruption or intentional tampering. For example, this may include calculating z-scores or using clustering techniques to identify data points that fall outside of the normal distribution. Verification may be successful if no significant anomalies are detected, suggesting that the data is consistent and reliable for training purposes. If anomalies such as outliers or unusual patterns are found, this may indicate potential data poisoning or manipulation, resulting in a failed verification. For example, telemetry information may be used—such as power consumption, temperature, and computing cycles—to create a profile of expected behavior for the machine learning model training running on particular hardware. The trusted profile may be generated from a known, secure environment, such as an end-user platform, and is used as a reference to compare against telemetry data collected from the model's execution on a third-party service provider's resources, such as a cloud service provider (CSP). Any deviations or anomalies in the telemetry data, such as unexpected power usage or processing times, may indicate that the model has been tampered with, substituted, or executed incorrectly. If the telemetry data from the CSP matches the trusted profile within an acceptable error margin, it suggests that the machine learning model training was legitimate and compliant with the intended configuration, ensuring that the correct machine learning model and data were used during inference (also described in the patent application by Intel (US Patent Application Ser. No. U.S. Ser. No. 18/753,830): “Methods, systems, articles of manufacture and apparatus to verify integrity of model execution on computing resources using telemetry information”) . . . . Conversely, if significant discrepancies are detected, it may indicate unauthorized actions, such as model substitution or misuse of computational resources, prompting the system to deny payment authorization or trigger additional security measures
2) Monitoring side-channel emissions in order to actively reduce (dampen/counteract) them.
3) Perform a noise/jitter injector by the noise injector 422. That may be done in concert with the telemetry observer 424 and may provide active cancellation of certain side channels for example, by introducing delays, spurious resource usage, throttling/pausing the learning. For example, this may be done by injecting random delays during execution of instructions, altering power consumption by running additional computations, or generating random traffic on the system bus to obscure memory access patterns. For timing-based side-channel attacks, random or deterministic delays can be added to specific operations, such as function calls or memory access, making it difficult for attackers to deduce the exact timing of operations. For power analysis attacks, noise can be introduced by executing power-hungry instructions that alter the power profile of the system, masking the power consumption patterns of sensitive operations. In the case of electromagnetic or acoustic emissions, additional instructions can be run concurrently to increase background noise, making it more challenging to isolate and analyze the emissions related to sensitive data processing. Additionally, noise can be injected at different levels of the execution environment, such as the runtime, hypervisor, or hardware layer, ensuring comprehensive protection against various attack vectors. For example, the noise injector may activate a noise injection mode in the runtime environment to execute pre-defined sets of instructions that increase power consumption or heat emission, or it may engage a hardware-based mechanism to generate electromagnetic noise. These techniques collectively disrupt the signal-to-noise ratio of potential side-channel leaks, making it significantly more difficult for an attacker to extract useful information from the observed signals (also described in the Patent Application by Intel (application Ser. No. 18/307,214): “Apparatuses, Methods and Computer Programs for Executing an Executable, and Method for Distributing Software or Firmware”).

In the third stage 330 an output guard 430 and/or a self-test telemetry 432 may be used. The output guard 430 may be the final gate for the updated machine learning model release back to the owner. Before it is done, a statistical test may be run on input vs. output and/or the telemetry during airlock-supervised learning may be compared with the expected. If everything checks out, the machine learning model may be released, together with optional feedback back to the training data provider indicating their contribution and issuing for example a bill-of-materials (BOM) for the machine learning model's provenance (possibly also a certificate of “quality”). The actual policy implementation may be governed by a smart contract and may include in some examples payments (for input data, but also for measured computing resources used for learning.

The (expected) self-test telemetry 432 may give the airlock control of all of I/O so that it may have full discretion of resetting/rewinding a learning process (for example this may also be applied in the first stage, generating self-test data). This may be used to inject special pure-artificial controlled test vectors to the machine learning model process (without learning framework knowing, for example a honeypot), to obtain a telemetry signature and observe the machine learning model weights change. The airlock may inject such test data at its own discretion and at any time. It may allow it to learn the expected telemetry profiles, but also spot deviations (if the same vector is injected at multiple insertion points, an outlier SCA emission may be a sign of a malicious model trying to exfiltrate data). After a successful test, the machine learning model state may be rewound, so that this test has no impact on the actual result.

FIG. 5 illustrates a first deployment mode 500 of the described technique. In the first deployment mode 500 the described airlock 530 is under the control of the machine learning model owner 520 (for example, the enterprise owning or operating the machine learning model). For example, the airlock 530 is operated at the local computation system 510 of the machine learning model owner 520. In this first deployment mode 500 the machine learning model may be transmitted to the airlock without encryption. However, each of the training data sets 540 (for example 1, . . . , N) from data providers 540 (1, . . . , N) may be individually encrypted and transmitted to the airlock 530. In the first deployment mode 500 the core security objectives solved by the airlock as described above are: To prevent the machine learning model from extracting raw data (for example through creating a rogue model outputting it directly or via side channels that the server administrator and/or model vendor may observe) and to prevent the machine learning model owner 520 from abusing the training data set (for example by not attributing to the data providers 540).

FIG. 6 illustrates a second deployment mode 600 of the described technique. In the second deployment mode 600 the described airlock 630 is under the control of the data provider 620. For example, the airlock 630 is operated at the local computation system 610 of the data provider 620. In this second deployment mode 600 the data may be transmitted to the airlock 630 without encryption. However, the machine learning model may be encrypted at transmission from the machine learning model owner 640 to the airlock 630 and on the transmission back. In the second deployment mode 600 the core security objectives solved by the airlock as described above are: To prevent the data provider 610 from extracting the machine learning mode during the machine learning model training (for example via side-channel emissions) and to prevent data provider 610 from crippling the machine learning model (for example via feeding poison data).

Further, in a third deployment mode, the technique as described above (that is the airlock) may be deployed at a trusted third-party. This deployment mode may combine the properties of the first deployment mode 500 and the second deployment mode 600.

In the following, some examples of the proposed concept are presented:

An example (e.g., example 1) relates to an apparatus for secure machine learning model training comprising interface circuitry, machine-readable instructions and processing circuitry to execute the machine-readable instructions to obtain a machine learning model and data within a trusted execution environment, wherein the data is configured for training of the machine learning model, and wherein the trusted execution environment secures a training of machine model against unauthorized access, verify at least one of the machine learning model and the data, perform training of the machine learning model based on the data, if the verification of the at least one of the data and the machine learning model is successful, verify the training process of the machine learning model, and output the trained machine learning model from the trusted execution environment, if the verification of the training process is successful.

Another example (e.g., example 2) relates to a previous example (e.g., example 1) or to any other example, further comprising that the processing circuitry is further to execute the machine-readable instructions to reduce a side-channel leakage emitted by the machine learning model during the training process of the machine learning model based on monitored side channel emissions of trusted execution environment and/or of the host system of the trusted execution environment.

Another example (e.g., example 3) relates to a previous example (e.g., example 2) or to any other example, further comprising that to reduce a side-channel leakage of the trusted execution environment comprises to add noise to the trusted execution environment operations during the training of the machine learning model.

Another example (e.g., example 4) relates to a previous example (e.g., one of the examples 2 to 3) or to any other example, further comprising that to reduce a side-channel leakage of the trusted execution environment comprises at least one of the following introducing a random delay during the training of the machine learning model, introducing additional resource usage into the training of the machine learning model, interrupting the training of the machine learning model at random intervals, randomizing code execution paths, and randomizing memory access patterns during the training of the machine learning model.

Another example (e.g., example 5) relates to a previous example (e.g., one of the examples 2 to 4) or to any other example, further comprising that the processing circuitry is further to execute the machine-readable instructions to monitor the side channel emissions of trusted execution environment.

Another example (e.g., example 6) relates to a previous example (e.g., one of the examples 1 to 5) or to any other example, further comprising that to verify the training process of the machine learning model comprises to perform a statistical test based on the input data and the trained machine learning model.

Another example (e.g., example 7) relates to a previous example (e.g., one of the examples 1 to 6) or to any other example, further comprising that to verify the training process of the machine learning model comprises to perform a statistical test based on monitored telemetry data during the training process of the machine learning model and reference telemetry data of the training process.

Another example (e.g., example 8) relates to a previous example (e.g., one of the examples 1 to 7) or to any other example, further comprising that to verify the training process of the machine learning model comprises to perform a self-test training of the machine learning model, the self-test being based on training the machine learning model with controlled test data.

Another example (e.g., example 9) relates to a previous example (e.g., one of the examples 1 to 8) or to any other example, further comprising that to verify the data comprises at least one of the following assessing the quantity of the data, analyzing the data for anomalies, assessing if a pre-determined payment amount for using the data for training is paid, and assessing if the data is malicious.

Another example (e.g., example 10) relates to a previous example (e.g., one of the examples 1 to 9) or to any other example, further comprising that to verify the machine learning model comprises to verify an origin of the machine learning model.

Another example (e.g., example 11) relates to a previous example (e.g., one of the examples 1 to 10) or to any other example, further comprising that the verification of the machine learning model is not successful if the machine learning model is assessed as being malicious.

Another example (e.g., example 12) relates to a previous example (e.g., example 11) or to any other example, further comprising that the machine learning model is assessed as being malicious if at least one of the following applies the machine learning model attempts to de-anonymize data, the machine learning model attempts to exfiltrate raw data, the machine learning model uses the training data beyond an allowed purpose, and the machine learning model operates without available consent.

Another example (e.g., example 13) relates to a previous example (e.g., one of the examples 1 to 12) or to any other example, further comprising that the verification of the machine learning model is successful if the data comprises at least a first pre-determined number of distinct data sets, each having a size of at least a second pre-determined number of samples, originating from different providers.

Another example (e.g., example 14) relates to a previous example (e.g., one of the examples 1 to 13) or to any other example, further comprising that the processing circuitry is further to execute the machine-readable instructions to degrade or improve the data based how much of a payment amount for using the data for training is paid.

Another example (e.g., example 15) relates to a previous example (e.g., one of the examples 1 to 14) or to any other example, further comprising that the processing circuitry is further to execute the machine-readable instructions to anonymize the data.

Another example (e.g., example 16) relates to a previous example (e.g., one of the examples 1 to 15) or to any other example, further comprising that the processing circuitry is further to execute the machine-readable instructions to generate a first certificate, the first certificate comprising an indication that the data was used to train the trained machine learning model.

Another example (e.g., example 17) relates to a previous example (e.g., one of the examples 1 to 16) or to any other example, further comprising that the processing circuitry is further to execute the machine-readable instructions to generate a second certificate, the second certificate comprising an indication of a quality of the data used for training of the machine learning model.

Another example (e.g., example 18) relates to a previous example (e.g., one of the examples 1 to 17) or to any other example, further comprising that the processing circuitry is further to execute the machine-readable instructions to perform a payment of a pre-determined payment amount to a payment address for using the data.

Another example (e.g., example 19) relates to a previous example (e.g., one of the examples 1 to 18) or to any other example, further comprising that the processing circuitry is further to execute the machine-readable instructions to decrypt the machine learning model and/or the data with a private key of a private-public key pair, wherein the machine learning model and/or the data are encrypted with a corresponding public key.

Another example (e.g., example 20) relates to a previous example (e.g., example 19) or to any other example, further comprising that the processing circuitry is further to execute the machine-readable instructions to generate, inside the trusted execution environment, the public-private key pair.

Another example (e.g., example 21) relates to a previous example (e.g., one of the examples 1 to 20) or to any other example, further comprising that the processing circuitry is further to execute the machine-readable instructions to instantiate the trusted execution environment.

Another example (e.g., example 22) relates to a previous example (e.g., example 21) or to any other example, further comprising that instantiating the trusted execution environment comprises generating attestation evidence of the trusted execution environment.

Another example (e.g., example 23) relates to a previous example (e.g., one of the examples 1 to 22) or to any other example, further comprising that to the trained machine learning model is input to the trusted execution environment together with second data.

An example (e.g., example 24) relates to a method for secure machine learning model training comprising obtaining a machine learning model and data within a trusted execution environment, wherein the data is configured for training of the machine learning model, and wherein the trusted execution environment secures a training of machine model against unauthorized access, verifying at least one of the machine learning model and the data, performing training of the machine learning model based on the data, if the verification of the at least one of the data and the machine learning model is successful, verifying the training process of the machine learning model, and outputting the trained machine learning model from the trusted execution environment, if the verification of the training process is successful.

Another example (e.g., example 25) relates to a previous example (e.g., example 23) or to any other example, further comprising reducing a side-channel leakage emitted by the machine learning model during the training process of the machine learning model based on monitored side channel emissions of trusted execution environment and/or of the host system of the trusted execution environment.

Another example (e.g., example 26) relates to a previous example (e.g., example 25) or to any other example, further comprising that to reduce a side-channel leakage of the trusted execution environment comprises to add noise to the trusted execution environment operations during the training of the machine learning model.

Another example (e.g., example 27) relates to a previous example (e.g., one of the examples 25 to 26) or to any other example, further comprising that to reduce a side-channel leakage of the trusted execution environment comprises at least one of the following introducing a random delay during the training of the machine learning model, introducing additional resource usage into the training of the machine learning model, interrupting the training of the machine learning model at random intervals, randomizing code execution paths, and randomizing memory access patterns during the training of the machine learning model.

Another example (e.g., example 28) relates to a previous example (e.g., one of the examples 25 to 27) or to any other example, further comprising monitoring the side channel emissions of trusted execution environment.

Another example (e.g., example 29) relates to a previous example (e.g., one of the examples 24 to 28) or to any other example, further comprising that to verify the training process of the machine learning model comprises to perform a statistical test based on the input data and the trained machine learning model.

Another example (e.g., example 30) relates to a previous example (e.g., one of the examples 24 to 29) or to any other example, further comprising that to verify the training process of the machine learning model comprises to perform a statistical test based on monitored telemetry data during the training process of the machine learning model and reference telemetry data of the training process.

Another example (e.g., example 31) relates to a previous example (e.g., one of the examples 24 to 30) or to any other example, further comprising that to verify the training process of the machine learning model comprises to perform a self-test training of the machine learning model, the self-test being based on training the machine learning model with controlled test data.

Another example (e.g., example 32) relates to a previous example (e.g., one of the examples 24 to 31) or to any other example, further comprising that to verify the data comprises at least one of the following assessing the quantity of the data, analyzing the data for anomalies, assessing if a pre-determined payment amount for using the data for training is paid, and assessing if the data is malicious.

Another example (e.g., example 33) relates to a previous example (e.g., one of the examples 24 to 32) or to any other example, further comprising that to verify the machine learning model comprises to verify an origin of the machine learning model.

Another example (e.g., example 34) relates to a previous example (e.g., one of the examples 24 to 33) or to any other example, further comprising that the verification of the machine learning model is not successful if the machine learning model is assessed as being malicious.

Another example (e.g., example 35) relates to a previous example (e.g., example 34) or to any other example, further comprising that the machine learning model is assessed as being malicious if at least one of the following applies the machine learning model attempts to de-anonymize data, the machine learning model attempts to exfiltrate raw data, the machine learning model uses the training data beyond an allowed purpose, and the machine learning model operates without available consent.

Another example (e.g., example 36) relates to a previous example (e.g., one of the examples 24 to 35) or to any other example, further comprising that the verification of the machine learning model is successful if the data comprises at least a first pre-determined number of distinct data sets, each having a size of at least a second pre-determined number of samples, originating from different providers.

Another example (e.g., example 37) relates to a previous example (e.g., one of the examples 24 to 36) or to any other example, further comprising degrading or improving the data based how much of a payment amount for using the data for training is paid.

Another example (e.g., example 38) relates to a previous example (e.g., one of the examples 24 to 37) or to any other example, further comprising anonymizing the data.

Another example (e.g., example 39) relates to a previous example (e.g., one of the examples 24 to 38) or to any other example, further comprising generating a first certificate, the first certificate comprising an indication that the data was used to train the trained machine learning model.

Another example (e.g., example 40) relates to a previous example (e.g., one of the examples 24 to 39) or to any other example, further comprising generating a second certificate, the second certificate comprising an indication of a quality of the data used for training of the machine learning model.

Another example (e.g., example 41) relates to a previous example (e.g., one of the examples 24 to 40) or to any other example, further comprising performing a payment of a pre-determined payment amount to a payment address for using the data.

Another example (e.g., example 42) relates to a previous example (e.g., one of the examples 24 to 41) or to any other example, further comprising decrypting the machine learning model and/or the data with a private key of a private-public key pair, wherein the machine learning model and/or the data are encrypted with a corresponding public key.

Another example (e.g., example 43) relates to a previous example (e.g., example 42) or to any other example, further comprising generating, inside the trusted execution environment, the public-private key pair.

Another example (e.g., example 44) relates to a previous example (e.g., one of the examples 24 to 43) or to any other example, further comprising instantiating the trusted execution environment.

Another example (e.g., example 45) relates to a previous example (e.g., example 44) or to any other example, further comprising that instantiating the trusted execution environment comprises generating attestation evidence of the trusted execution environment.

Another example (e.g., example 46) relates to a previous example (e.g., one of the examples 24 to 45) or to any other example, further comprising that to the trained machine learning model is input to the trusted execution environment together with second data.

An example (e.g., example 47) relates to an apparatus for secure machine learning model training comprising a processor circuitry configured to obtain a machine learning model and data within a trusted execution environment, wherein the data is configured for training of the machine learning model, and wherein the trusted execution environment secures a training of machine model against unauthorized access, verify at least one of the machine learning model and the data, perform training of the machine learning model based on the data, if the verification of the at least one of the data and the machine learning model is successful, verify the training process of the machine learning model, and output the trained machine learning model from the trusted execution environment, if the verification of the training process is successful.

An example (e.g., example 48) relates to a device for secure machine learning model training comprising means for processing for obtaining a machine learning model and data within a trusted execution environment, wherein the data is configured for training of the machine learning model, and wherein the trusted execution environment secures a training of machine model against unauthorized access, verifying at least one of the machine learning model and the data, performing training of the machine learning model based on the data, if the verification of the at least one of the data and the machine learning model is successful, verifying the training process of the machine learning model, and outputting the trained machine learning model from the trusted execution environment, if the verification of the training process is successful.

Another example (e.g., example 49) relates to a non-transitory machine-readable storage medium including program code, when executed, to cause a machine to perform the method of any one of examples 24 to 46.

Another example (e.g., example 50) relates to a computer program having a program code for performing the method of any one of examples 24 to 46 when the computer program is executed on a computer, a processor, or a programmable hardware component.

Another example (e.g., example 51) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for secure machine learning model training comprising interface circuitry, machine-readable instructions and processing circuitry to execute the machine-readable instructions to:
obtain a machine learning model and data within a trusted execution environment, wherein the data is configured for training of the machine learning model, and wherein the trusted execution environment secures a training of machine model against unauthorized access;
verify at least one of the machine learning model and the data;
perform training of the machine learning model based on the data, if the verification of the at least one of the data and the machine learning model is successful;
verify the training process of the machine learning model; and
output the trained machine learning model from the trusted execution environment, if the verification of the training process is successful.

2. The apparatus of claim 1, wherein the processing circuitry is further to execute the machine-readable instructions to reduce a side-channel leakage emitted by the machine learning model during the training process of the machine learning model based on monitored side channel emissions of trusted execution environment and/or of the host system of the trusted execution environment.

3. The apparatus of claim 2, wherein to reduce a side-channel leakage of the trusted execution environment comprises to add noise to the trusted execution environment operations during the training of the machine learning model.

4. The apparatus of claim 2, wherein to reduce a side-channel leakage of the trusted execution environment comprises at least one of the following: introducing a random delay during the training of the machine learning model, introducing additional resource usage into the training of the machine learning model, interrupting the training of the machine learning model at random intervals, randomizing code execution paths, and randomizing memory access patterns during the training of the machine learning model.

5. The apparatus of claim 2, wherein the processing circuitry is further to execute the machine-readable instructions to monitor the side channel emissions of trusted execution environment.

6. The apparatus of claim 1, wherein to verify the training process of the machine learning model comprises to perform a statistical test based on the input data and the trained machine learning model.

7. The apparatus of claim 1, wherein to verify the training process of the machine learning model comprises to perform a statistical test based on monitored telemetry data during the training process of the machine learning model and reference telemetry data of the training process.

8. The apparatus of claim 1, wherein to verify the training process of the machine learning model comprises to perform a self-test training of the machine learning model, the self-test being based on training the machine learning model with controlled test data.

9. The apparatus of claim 1, wherein to verify the data comprises at least one of the following: assessing the quantity of the data, analyzing the data for anomalies, assessing if a pre-determined payment amount for using the data for training is paid, and assessing if the data is malicious.

10. The apparatus of claim 1, wherein to verify the machine learning model comprises to verify an origin of the machine learning model.

11. The apparatus of claim 1, wherein the verification of the machine learning model is not successful if the machine learning model is assessed as being malicious.

12. The apparatus of claim 11, wherein the machine learning model is assessed as being malicious if at least one of the following applies: the machine learning model attempts to de-anonymize data, the machine learning model attempts to exfiltrate raw data, the machine learning model uses the training data beyond an allowed purpose, and the machine learning model operates without available consent.

13. The apparatus of claim 1, wherein the verification of the machine learning model is successful if the data comprises at least a first pre-determined number of distinct data sets, each having a size of at least a second pre-determined number of samples, originating from different providers.

14. The apparatus of claim 1, wherein the processing circuitry is further to execute the machine-readable instructions to degrade or improve the data based how much of a payment amount for using the data for training is paid.

15. The apparatus of claim 1, wherein the processing circuitry is further to execute the machine-readable instructions to anonymize the data.

16. The apparatus of claim 1, wherein the processing circuitry is further to execute the machine-readable instructions to generate a first certificate, the first certificate comprising an indication that the data was used to train the trained machine learning model.

17. The apparatus of claim 1, wherein the processing circuitry is further to execute the machine-readable instructions to generate a second certificate, the second certificate comprising an indication of a quality of the data used for training of the machine learning model.

18. The apparatus of claim 1, wherein the processing circuitry is further to execute the machine-readable instructions to instantiate the trusted execution environment.

19. A method for secure machine learning model training comprising:
obtaining a machine learning model and data within a trusted execution environment, wherein the data is configured for training of the machine learning model, and wherein the trusted execution environment secures a training of machine model against unauthorized access;
verifying at least one of the machine learning model and the data;
performing training of the machine learning model based on the data, if the verification of the at least one of the data and the machine learning model is successful;
verifying the training process of the machine learning model; and
outputting the trained machine learning model from the trusted execution environment, if the verification of the training process is successful.

20. A non-transitory machine-readable storage medium including program code, when executed, to cause a machine to perform the method of claim 19.
